(19) United States
(12) Patent Application Publication
(10) Pub. No.: US 2006/0139869 A1
(43) Pub. Date: Jun. 29, 2006

(54) Extended compression arrangements within telecommunication systems and associated methods

(76) Inventor: Pawel Oskar Matusz, Rumia (PL)

Correspondence Address: SCHWEGMAN, LUNDBERG, WOESSNER & KLUTH, P.A., P.O. BOX 2938, MINNEAPOLIS, MN, 55402, US

(21) Appl. No.: 11/027,771

(22) Filed: Dec. 29, 2004

(51) Int. Cl. G06F 1/16

(52) U.S. Cl. 361/685

(57) ABSTRACT

An arrangement extends the use of data compression throughout a telecommunications network. In an embodiment, packet data compression is extended throughout various operations of a core network. Increased bandwidth and more efficient use of network resources may result.

### TECHNICAL FIELD

The present subject matter pertains to telecommunication systems and, more particularly, to extended compression use within a telecommunication system.

### BACKGROUND

In known mobile telecommunication technology, various mobile user equipment may link with a radio access network for mobile communications. Packets may be transmitted through the radio access network. The radio access network may include wireless or wireline connections.

Data packet switching and control may be performed by a core network. The radio access network may send a data packet communication over a wireless or wireline link to the core network. The core network may then switch or route the data packet to other mobile user equipment or via various gateways to the Internet or to other communication systems.

Data packets that are transmitted from the mobile user equipment to the radio access network are sent to the core network. The data packets may each have a packet data header. A packet data header helps route the packet to its proper destination within the network or outside of the network. Packet header information is used to route each data packet properly, but it forms an overhead burden for the amount of data that must be transmitted over various communication links. The data contained within the packet (i.e., the “payload”) may be information pertaining to the ongoing communication.

In these known mobile telecommunication systems, data packets may be transmitted in a number of different formats or protocols. These protocols exist for the convenience of the various components in a telecommunication system. With standard protocols, a number of manufacturers may provide the various equipment used in these telecommunication systems.

### BRIEF DESCRIPTION OF THE DRAWINGS

FIG. 1 is a block diagram of a mobile telecommunication system that incorporates an embodiment of the present invention.

FIG. 2 is a block diagram depicting the extension of packet data compression protocol functionality to a core network, in accordance with an embodiment of the present invention.

FIG. 3 is a block diagram of various protocol stacks in accordance with an embodiment of the present invention.

FIG. 4 is a block diagram of various protocol stacks associated with another embodiment of the present invention.

FIG. 5 is a flow chart of a compression extension method in accordance with an embodiment of the present invention.

### DETAILED DESCRIPTION

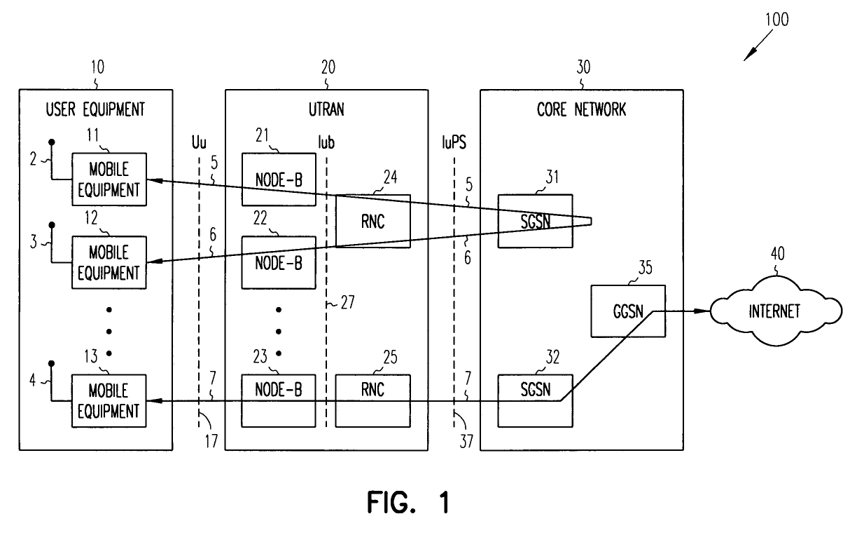

FIG. 1 is a block diagram of a mobile telecommunication system 100 that incorporates an embodiment of the present invention. Functionally, mobile telecommunication system 100 may be divided into three parts. The first part comprises user equipment 10. The second part comprises a “UTRAN” (UMTS terrestrial radio access network) 20. “UMTS” is a universal mobile telecommunications system. The third part of system 100 comprises core network 30.

Abbreviations and acronyms used throughout this document may currently be found at a URL that includes “3gpp.org” (to avoid inadvertent hyperlinks, the “www” has been omitted from the foregoing URL.) in 3G TR 21.905 3^{rd} Generation Partnership Project Vocabulary for 3GPP published Oct. 21, 1999.

In FIG. 1, embodiments of the present invention are shown for moving PDCP (Packet Data Compression Protocol) functionality from UTRAN 20 to core network 30, thus preserving precious bandwidth on most UMTS interfaces. The PDCP functionality may be performed, in an embodiment, by an SGSN 31, 32 or GGSN 35 within the core network 30. The term “SGSN”, as used herein, denotes a “GPRS support node”. The term “GPRS”, as used herein, indicates a “general packet radio service”. The term “GGSN”, as used herein, denotes a “gateway GPRS support node”. User equipment 10 may include mobile equipment 11, 12 and 13. Mobile equipment 11-13 may include portable communication devices such as cell phones, wireless computers, personal digital assistants, pagers and other types of wireless communication devices capable of communication within a mobile telecommunication system 100.

Wireless interface “Uu” is indicated by dashed vertical line 17 and provides for wireless links, such as links 5, 6 and 7. Wireless interface 17 wirelessly couples the user equipment 10 to the UTRAN 20 via a radio interface or wireless link. In mobile telecommunication system 100, UTRAN 20 may include a number of “Node-B” units coupled to the user equipment via wireless interface 17. In an embodiment, Node-Bs 21-23 comprise base stations.

Node-Bs 21-23 are coupled to one of the radio network controllers (“RNC”) 24 and 25 via an “Iub” interface indicated by dashed line 27. Iub interface 27 is an interface between Node-Bs 21-23 and one of the RNCs 24-25. The Iub interface 27 may be a wireline or wireless interface. Iub interface 27 may include a microwave link.

UTRAN 20 couples communications from user equipment 10 to the core network 30 for switching and routing purposes. Interface “IuPS” 37 couples the RNCs 24 and 25 to the core network 30. Interface IuPS for packet-switched applications may be replaced with interface “IuCS” for circuit-switched applications. Specifically, the IuPS interface couples RNCs 24 and 25 to serving GPRS support node (“SGSN”) 31 and 32. “GPRS” indicates a general packet radio service. Either SGSN 31 or 32 may couple the communication originating from user equipment 10 to gateway GPRS support node (“GGSN”) 35. GGSN is a gateway and establishes connections with various other communication systems such as Internet 40. Internet 40 represents not only the Internet but other mobile systems or wireless or wireline communication systems of any suitable type (not shown).

Each of the mobile equipment 11, 12 and 13 has a corresponding antenna 2, 3 and 4, respectively, to enable communication via wireless link 17 with UTRAN 20. Antennas 2, 3 and 4 may comprise a directional or omni-directional antenna, including, for example, a dipole antenna, a monopole antenna, a patch antenna, a loop antenna, a microstrip antenna or other type of antenna suitable for transmission and reception of packet data signals.

Further, referring to FIG. 1, couplings or links 5 and 6 enable a call or data communication connection between mobile equipment, such as between mobile equipment 11 and mobile equipment 12. Let us assume that mobile equipment (ME) 11 is communicating with ME 12. ME 11 is coupled via a mobile Uu link 17 to Node-B 21 of UMTS terrestrial radial access network (UTRAN) 21. Node-B 21 couples the communication originating from ME 11 to radio network controller (RNC) 24 via the Iub link 27. Continuing with the present example, RNC 24 transmits the communication on an IuPS interface 37 to SGSN 31 of core network 30.

SGSN 31 performs appropriate routing and switching and determines that ME 12 is the target of the communication. As a result, SGSN 31 establishes a communication channel or wireless link 5 or 6 via the IuPS interface 37 to RNC 24. Although RNC 24 is being used in the present example, RNC 25 may be used for the communication channel 6, as may any other RNC that serves ME 12.

Further in the present example, RNC 24 may then establish a communication channel with Node-B 22 via the Iub link 27, although any Node-B serving ME 12 may also be used.

Node-B 22 then establishes a communication channel with ME 12 via a Uu link 17 through antenna 3. As a result, a communication channel in the form of links 5-6 is established from ME 11, through Node-B 21, through RNC 24, through SGSN 31, through RNC 24, and through Node-B 22 to ME 12.

For the case when a mobile equipment (ME) is attempting to couple to an external network, such as Internet 40, link 7 may be established. ME 13, for example, may attempt to communicate through Internet 40. First, a wireless link 7 through interface Uu 17 is established between ME 13 and Node-B 23 via antenna 4. As mentioned earlier, the Uu interface 17 supports wireless link 7 and may be wireline or wireless.

RNC 25 further extends the communication channel or wireless link 7 to SGSN 32 via an IuPS interface 37, which may be either wireline or wireless. SGSN 32 then routes and switches the communication channel or links. Since this example is dealing with a communication to Internet 40, which is an external network, SGSN 32 will establish a communication link 7 through gateway GPRS support node (“GGSN”) 35 to Internet 40. The communication channel or link 7 may then be extended not only to Internet 40, but to various other external networks (not shown).

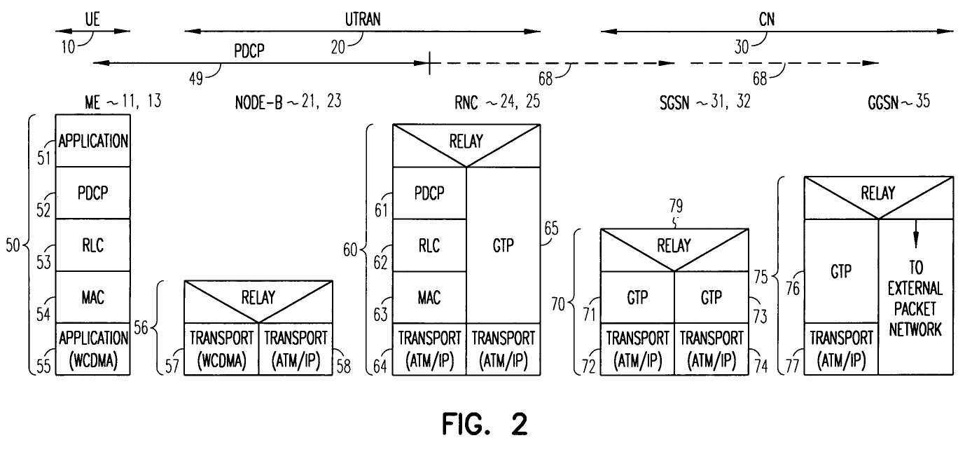

FIG. 2 is a block diagram depicting the extension of packet data compression protocol functionality to a core network 30, in accordance with an embodiment of the present invention. In FIG. 2, various protocol stacks 50, 56, 60, 70, and 75 are illustrated. The elements (protocols) of the various protocol stacks 50, 56, 60, 70, and 75 ensure correct data exchange between specific network elements, e.g. between mobile equipment 11 and the Internet 40. Where a block labeled “relay” is shown in FIG. 2, it indicates a binding of two different protocol stacks on two separate interfaces of the device depicted. The following protocol stack explanation focuses on packet data compression protocol (PDCP) as a representative example of a protocol, but not of all protocols of a UMTS system.

Protocol stack 50 is shown for user equipment 10 (e.g. mobile equipment 11-13). Protocol stack 50 includes an application level protocol 51, a packet data compression protocol (PDCP) 52, a radio link control (RLC) protocol 53, a medium access control (MAC) protocol 54, and a transport protocol, which in an embodiment is shown as a wideband code division multiple access (WCDMA) protocol 55. In an embodiment, the PDCP protocol stack level 52 of a data packet is compressed by the user equipment 10.

Next, a Node-B protocol stack 56 is shown. On the Uu interface, stack 56 has a transport WCDMA protocol 57. On the Iub interface, asynchronous transfer mode (ATM) protocol or internet protocol 58 may be used.

Next, an RNC protocol stack 60 is depicted. PDCP protocol 61, RLC protocol 62, MAC protocol 63, and transport protocol (either ATM or IP) 64 are shown on the Iub interface 27.

On the IuPS interface 37 with core network 30, RNC protocol stack 60 includes GPRS tunneling protocol (“GTP”) 65 and a transport protocol (either ATM or IP) 66.

SGSNs 31, 32 are on the other side of the IuPS interface 37. Protocol stack 70 represents the protocols for the SGSNs 31, 32. On the IuPS interface 37, GTP protocol 71 and ATM/IP protocol 72 are included in the protocol stack 70. On the interface between the SGSNs 31, 32 and the GGSN 35, a GTP protocol 73 and a transport protocol (either ATM or IP) 74 are also included.

For the GGSN 35, which interfaces to the SGSNs 31 or 32, a GTP protocol 76 and transport protocol ATM/IP 77 are included. Lastly, protocol stack 75 includes a suitable external protocol as may be required by the external packet network to which it is coupled, for example, the Internet 40.

As shown in FIG. 2, a typical, known PDCP protocol is represented by the solid arrow 49 along the top of FIG. 2 between ME 11-13 and RNC 24, 25. To represent conceptually an embodiment of the present invention, dashed arrows 68 are shown extended to both the SGSNs 31 and 32 and to the GGSN 35 or, to generalize, anywhere in the core network 30. Referring to FIG. 1, the Uu 17 and Iub 27 interfaces of the communication channel or the links (5-7) use the packet data compression protocol and links 5-7 to extend the PDCP use to the core network 30.

Each data packet has a packet header. These headers may be approximately 28 bytes or more in length. A packet data compression protocol typically compresses these headers down to between 5 and 7 bytes. Thus, for 100-byte packets, this provides about 20% more available throughput, so PDCP saves precious bandwidth. Whereas in known systems, packet headers are only compressed across the Uu 17 and Iub 27 interfaces, and not at other interfaces, such as the IuPS interface 37, in embodiments of the present invention PDCP functionality is moved from UTRAN 20 to the core network 30, thus potentially saving 20% of bandwidth throughout most of the system 100. This potentially allows system 100 to handle more subscribers.

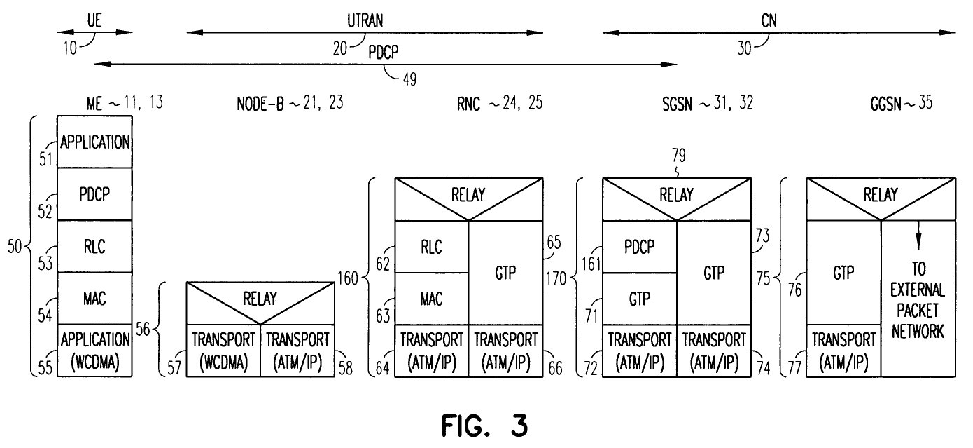

FIG. 3 is a block diagram of various protocol stacks in accordance with an embodiment of the present invention. The mobile equipment protocol stack 50 may be similar to or identical to stack 50 in FIG. 2. Similarly, the Node-B protocol stack 56 may be equivalent to stack 56 in FIG. 2.

For the RNCs 24 and 25, protocol stack 160 has been modified from its appearance 60 in FIG. 2. Protocol stack 160 does not include the PDCP (packet data compression protocol) 61 that protocol stack 60 has. That is, no packet data or packet data header compression is performed by the RNCs 24 and 25. Other protocols 62-66 may be similar or identical to those shown in FIG. 2.

On the other side of the IuPS interface 37 (refer to FIG. 1), SGSN 31, 32 of core network 30 now include a PDCP (packet data compression protocol) 161 as a protocol layer in the protocol stack 170. In an embodiment, the PDCP protocol stack level 161 of a data packet may be decompressed by SGSN 31 of core network 30. As now shown by the solid PDCP arrow 49 along the top of FIG. 3, the packet data compression extends between the user equipment 10 (e.g. MEs 11-13) and the SGSN 31, 32 of core network 30. Arrow 49 depicts an embodiment of the present invention for moving the PDCP functionality either to an SGSN 31, 32 or SSGN 35 of core network 30.

The radio network controller 24 forwards the compressed data packet to the core network 30 over the IuPS packet data communication link 37 (refer to FIG. 1). Instead of the packet data compression protocol (PDCP) spanning only interfaces Uu 17 and Iub 27 between the user equipment and RNC, the PDCP packets now also span the IuPS interface 37 from mobile equipment 11-13 to SGSNs 31, 32 of core network 30.

In an embodiment, the PDCP protocol stack level of a data packet is compressed by the user equipment 10. In an embodiment of the present invention, packet data headers may be compressed from about 30 bytes to about 5 bytes, and this compression is transmitted on the communication channel between the user equipment 10 and core network 30, specifically SGSN 31, 32. In another embodiment, a 60 byte packet data header may be compressed from 60 bytes to about 10-15 bytes.

This yields a 20% or more savings in transmitted packet header data. This savings in packet data header may be used to increase the payload or communication data of each channel. As a result, the bandwidth of a mobile communication system embodying an embodiment of the present invention may provide approximately 20% more bandwidth. As a result, third generation (3G) system operators using embodiments of the present invention may potentially handle more subscribers and more economically manage their network resources.

For decompressed data packets arriving at a SGSN 31 or 32, the SGSN may compress the packet data header. The compressed data packet may be transmitted wirelessly to UTRAN 20 and through an RNC 24 or 25 and a Node-B 21-23. Then the data packet may be sent via the Uu wireless link 17 to a mobile equipment 11-13, where the data packet may then be decompressed. Either SGSN 31, 32 or a mobile equipment 11-13 may compress or decompress the data packet.

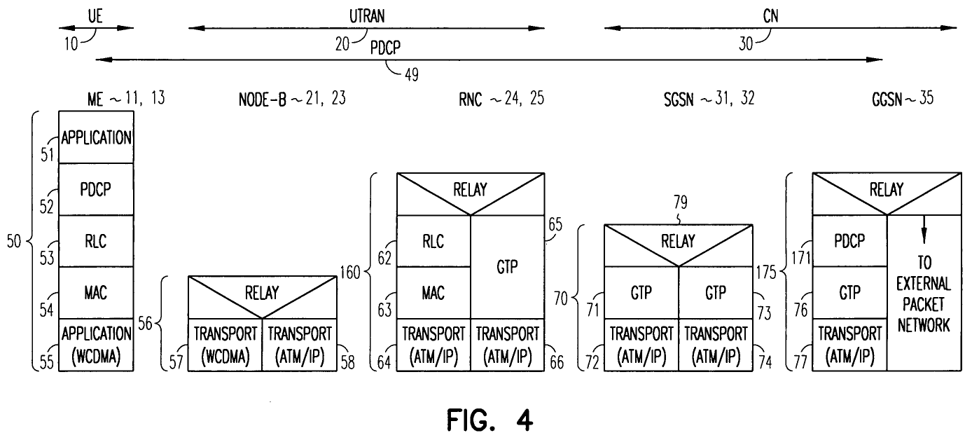

FIG. 4 is a block diagram of various protocol stacks associated with another embodiment of the present invention.

Mobile equipment protocol stack 50 of user equipment 10 may be similar to or identical to that depicted in FIGS. 2-3. Similarly, Node-B protocol stack 56 may be similar to or identical to protocol stack 56 of FIGS. 2-3. The protocol stacks 160 of radio network controller 24, 25 may be the same as protocol stacks 160 shown in FIG. 3.

Protocol stack 79 on the interface IuPS 37 between an RNC and an SGSN excludes the PDCP protocol 161 shown in FIG. 3. The PDCP protocol may exist within protocol stack 79, but an SGSN is inhibited from performing a decompression when the destination of the data packet indicates that the data packet will be communicated through the GGSN 35 to an external network. Protocol stack 79 now includes the GTP protocol 71 and the transport protocol (either ATM or IP) 72 on the IuPS interface 37 with the RNCs 24, 25. Similarly, on the SGSN/GGSN interface, protocol stack 79 includes the GTP protocol 73 and transport protocol (either ATM or IP) 74.

GGSN protocol stack 175 includes, on the GGSN/SGSN interface, the packet data compression protocol 171 in addition to the GTP protocol 76 and transport protocol (either ATM or IP) 77. In an embodiment, the PDCP protocol stack level 171 of a data packet may be decompressed by GGSN 35 of core network 30. The PDCP interface, as indicated by arrow 49 shown along the top of FIG. 4, now extends from mobile equipment 11-13 to GGSN 35. The communication channel is similar to link 7 for communication between mobile equipment and an external packet network such as Internet 40. The GGSN protocol stack 175 may perform any necessary protocol based on the communication network with which it is communicating or attempting to connect.

Again, 20% or more of the bandwidth may be saved as a result of extending packet data header compression from mobile equipment 11-13 all the way to the GGSN 35.

For decompressed data packets arriving at GGSN 35, the GGSN 35 compresses the packet data header. The compressed data packet is then sent through SGSN 31 or 32. SGSN 31 or 32 is inhibited from performing the compression, since it has already been performed by GGSN 35. The compressed data packet is transmitted wirelessly via the IuPS link 37 to UTRAN 20 and through an RNC 24, 25 and a Node-B 21-23. Then the data packet is sent via the Uu wireless link 17 to a mobile equipment 11-13, where the data packet is then decompressed. Either GGSN 35 or a mobile equipment 11-13 may compress or decompress the data packet.

For data packets arriving from other networks, such as Internet 40, a link 7 is established, and PDCP protocol compression is performed by GGSN 35 of core network 30. The compression is similar to that performed by the MEs. Since the compression is performed by GGSN 35, the SGSNs 31 and 32 will be inhibited from performing any compression on the previously compressed data packets. The data packets are then transmitted from GGSN 35 through either SGSN 31 or 32. For the present example, SGSN 32 will transmit the data packets on link 7 via the IuPS interface 37.

The compressed data packets will be received by RNC 25, for example. Since Node-B 23 is bound to RNC 25 in this example, RNC 25 will transmit the data packet on link 7 via the Iub interface 27 to Node-B 23.

Node-B 23 then sends the compressed data packets on link 7 via Uu interface 17. The compressed data packets are then received by mobile equipment 13, for example. Mobile equipment 13 performs the decompression of the compressed data packet. The protocol stacks are as shown in FIG. 4; however, the packet data flow is in the opposite direction from that discussed above.

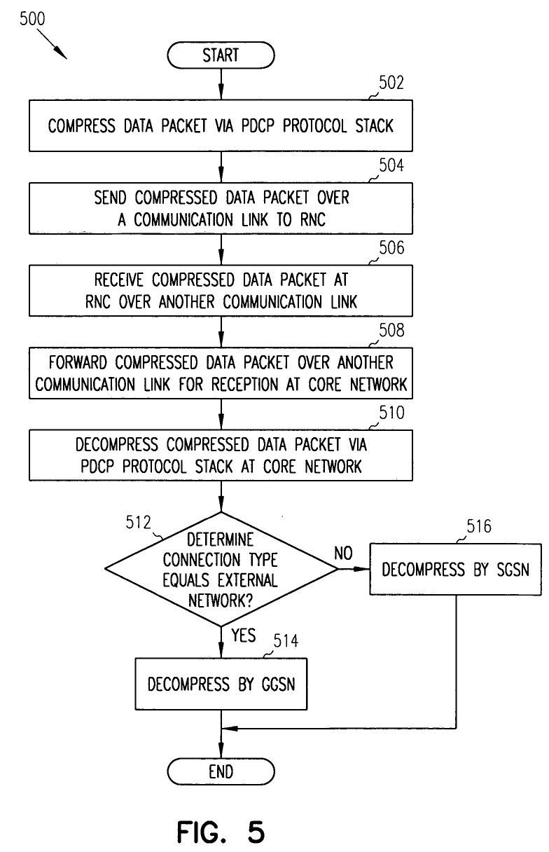

FIG. 5 is a flow chart of a compression extension method 500 in accordance with an embodiment of the present invention. Compression extension method 500 is started, and block 502 is entered. In block 502, one or more of user equipment 10 compresses a data packet via PDCP (e.g., in protocol stack level 52, FIGS. 2-4) to produce a compressed data packet. In block 504, user equipment 10 sends the compressed data packet to one of the radio network controllers (RNC) 24, 25. In doing so, the compressed data packet is sent over the Uu packet data communication link 17 to a Node-B 21-23 associated with an RNC 24, 25.

In block 506, Node-B forwards the data packet over a communication link Iub 27 to one RNC 24 or 25, where it is received. In block 508, one of the RNCs 24 or 25 forwards the compressed data packet over another packet data communication link IuPS 37 to core network 30. In block 510, the core network 30 may decompress the compressed data packet.

Once the compressed data packet is received by the core network 30, block 512 determines whether the compressed data packet is to be routed to an external network, such as Internet 40, for example. If the connection type of the data packet indicates an external network, block 512 transfers control to block 514 via the YES path. In block 514, the compressed data packet is decompressed by the GGSN (gateway GPRS support node) 35. In this event, any decompression by SGSNs (serving GPRS support nodes) 31 and 32 would be inhibited. The process is ended.

If the connection type indicates that an external network is not required, block 512 transfers control to block 516 via the NO path. In block 516, one of the SGSNs 31 or 32 may perform the decompression of the decompressed data packet. The process is ended. It will be understood that, although “Start” and “End” blocks are shown, the method(s) may be performed continuously.

It should be noted that the methods herein do not have to be executed in the order described, or in any particular order. Moreover, various activities described with respect to the methods identified herein can be executed in serial or parallel fashion.

Third-generation (3G) system may be able to handle more subscribers and more economically provision network resources as a result of moving the PDCP function into the core network.

Although some embodiments of the present invention are discussed in the context of an 802.11x implementation (e.g., 802.11a, 802.11g, 802.11 HT, etc.), the scope of embodiments of the present invention is not limited in this respect. Some embodiments of the present invention may be implemented as part of any wireless system using multi-carrier wireless communication channels (e.g., orthogonal frequency-division multiplexing (OFDM), discrete multi-tone modulation (DMT), etc.), such as may be used within, without limitation, a wireless personal area network (WPAN), a wireless local area network (WLAN), a wireless metropolitan are network (WMAN), a wireless wide area network (WWAN), a cellular network, a third-generation (3G) network, a fourth-generation (4G) network, a universal mobile telephone system (UMTS), and like communication systems.

The description and the drawings illustrate specific embodiments of the invention sufficiently to enable those skilled in the art to practice them. Examples merely typify possible variations. Portions and features of some embodiments may be included in or substituted for those of others.

Although some embodiments of the invention have been illustrated, and those forms described in detail, it will be readily apparent to those skilled in the art that various modifications may be made therein without departing from the spirit of these embodiments or from the scope of the appended claims.

What is claimed is:

1. A method comprising:
performing packet header compression and decompression on a data packet sent between a user mobile terminal through a radio network controller to a core network, the compression and decompression being performed within the user mobile terminal and within the core network, respectively.

2. The method of claim 1, wherein the compression and decompression are not performed within the radio network controller.

3. The method of claim 1, wherein the data packet is sent wirelessly through a first packet-switched communication link between the user mobile terminal and the radio network controller, and wherein the data packet is sent wirelessly through a second packet-switched communication link between the radio network controller and the core network.

4. The method of claim 1, wherein the compressing and decompressing are performed using at least one packet data compression protocol stack.

5. A method comprising:
compressing a specific protocol stack level of a data packet to provide a compressed data packet;
sending the compressed data packet through a first packet-switched communication link;
receiving the compressed data packet at a radio network controller;
forwarding the compressed data packet through a second packet-switched communication link;
receiving the compressed data packet at a core network; and
decompressing the specific protocol stack level of the compressed data packet by the core network.

6. The method of claim 5, wherein the compressing includes compressing the data packet using a packet data compression protocol (PDCP) stack.

7. The method of claim 5, wherein the sending includes sending the compressed data packet wirelessly over the first packet-switched communication link to the radio network controller.

8. The method of claim 7, wherein the sending includes sending the compressed data packet wirelessly over the second packet-switched communication link within the radio network controller.

9. The method of claim 8, wherein the sending includes sending the compressed data packet wirelessly over a third packet-switched communication link to the core network.

10. The method of claim 8, wherein decompressing the specific protocol stack level of the compressed data packet is performed by a first unit of the core network.

11. The method of claim 10, wherein decompressing by the first unit is performed by a serving GPRS (general packet radio service) support node (SGSN).

12. The method of claim 10, wherein decompressing the compressed data packet further includes:
determining a connection type of the compressed data packet; and
if the connection type indicates an external network, inhibiting the decompressing of the compressed data packet by the first unit.

13. The method of claim 12, wherein decompressing the specific protocol stack level of the compressed data packet is performed by a second unit of the core network.

14. The method of claim 13, wherein decompressing by the second unit is performed by a gateway GPRS (general packet radio service) support node (GGSN), if the connection type indicates the external network.

15. An apparatus comprising:
a radio access network to receive a compressed data packet and to forward the compressed data packet to a core network over a packet data communication link, the radio access network being coupled to the core network; and
the core network to decompress the compressed data packet.

16. The apparatus of claim 15, wherein the core network includes a packet data compression protocol (PDCP) stack to decompress the compressed data packet.

17. The apparatus of claim 15, wherein the packet data communication link includes a first wireless communication link to transmit the compressed data packet from the radio access network to the core network.

18. The apparatus of claim 17, further comprising a second wireless communication link to transmit the compressed data packet from a Node-B to a radio network controller within the radio access network.

19. The apparatus of claim 18, further comprising a third wireless communication link to transmit the compressed data packet from a user equipment to the radio access network.

20. The apparatus of claim 15, wherein the core network includes a serving GPRS (general packet radio service) support node (SGSN) to decompress the compressed data packet.

21. The apparatus of claim 20, wherein the serving GPRS (general packet radio service) support node (SGSN) is further operated to compress the data packet to provide a compressed data packet.

22. The apparatus of claim 15, wherein the core network further includes a gateway GPRS (general packet radio service) support node (GGSN) to decompress the compressed data packet.

23. The apparatus of claim 22, wherein the gateway GPRS (general packet radio service) support node (GGSN) is further operated to compress the data packet to provide a compressed data packet.

24. A machine-accessible medium having associated instructions, wherein the instructions, when accessed, result in a machine performing:
compressing a specific protocol stack level of a data packet to provide a compressed data packet;
sending the compressed data packet to a radio network controller;
forwarding the compressed data packet by the radio network controller through a packet-switched communication link to a core network; and
decompressing the specific protocol stack level of the compressed data packet by the core network.

25. The machine-accessible medium of claim 24, wherein the compressing includes compressing the data packet using a packet data compression protocol stack.

26. The machine-accessible medium of claim 24, wherein the sending includes sending the compressed data packet via a communication link from a user equipment to the radio access network.

27. The machine-accessible medium of claim 24, wherein the sending includes sending the compressed data packet via a communication link from a Node-B to a radio network controller within the radio access network.

28. A system comprising:
user equipment to compress a data packet to provide a compressed data packet;
a radio access network to forward the compressed data packet to a core network over a packet data communication link, the radio access network coupled to the user equipment and to the core network; and
the core network to decompress the compressed data packet, the core network coupled to the radio access network; and
a substantially omni-directional antenna to couple the user equipment to the radio access network via a wireless communication link.

29. The system as claimed in claim 28, wherein the core network includes a serving GPRS (general packet radio service) support node (SGSN) to decompress the compressed data packet.

30. The system as claimed in claim 28, wherein the core network further includes a gateway GPRS (general packet radio service) support node (GGSN) to decompress the compressed data packet.
